(19) United States
(12) Patent Application Publication
(10) Pub. No.: US 2013/0266153 A1
(43) Pub. Date: Oct. 10, 2013

(54) ANTI-POP CIRCUIT

(71) Applicants: QIANG NIE, Shenzhen City (CN); XIAO-ZHAN PENG, Shenzhen City (CN); CHUN-LUNG HUNG, Tu-Cheng (TW); HSING-SUANG KAO, Tu-Cheng (TW)

(72) Inventors: QIANG NIE, Shenzhen City (CN); XIAO-ZHAN PENG, Shenzhen City (CN); CHUN-LUNG HUNG, Tu-Cheng (TW); HSING-SUANG KAO, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/534,280

(22) Filed: Jun. 27, 2012

(30) Foreign Application Priority Data
Apr. 9, 2012 (CN) 201210101756.6

(51) Int. Cl. H04B 15/00

(52) U.S. Cl. 381/94.5

(57) ABSTRACT

An exemplary anti-pop circuit for use in an electronic device includes a switch module, a first path module, and a second control module. The first path module outputs a first response signal when the electronic device is being started, the switch module cuts off the connection between the audio IC and the speaker in response to the first response signal. The second control module includes a charge/discharge unit and a second path module. The charge/discharge unit is charged by the DC power supply when the electronic device is being started, and discharges to the second path module when the electronic device is being shut down. The second path module outputs a second response signal when the electronic device is being shut down, the switch module cuts off a connection between the audio IC and the speaker in response to the second response signal.

### BACKGROUND

1. Technical Field

The present disclosure relates to electrical circuits and, more particularly, to an anti-pop circuit.

2. Description of Related Art

In a conventional anti-pop circuit, a CPU is employed to control the connection between an audio IC and a speaker. However, when the power supplied to the CPU is cut off, the CPU can not work normally. Thus, a “pop” sound is always intermixed with the output sound signal the moment the power (Vcc) is turned on or off due to voltage spiking. It is desirable to provide an anti-pop circuit the resolves this problem.

### BRIEF DESCRIPTION OF THE DRAWINGS

The components in the drawings are not necessarily drawn to scale, the emphasis instead being placed upon clearly illustrating the principles of the anti-pop circuit. Moreover, in the drawings, like reference numerals designate corresponding parts throughout the several views.

FIG. 1 is a block diagram of an anti-pop circuit in accordance with an exemplary embodiment.

FIG. 2 is a circuit diagram of the anti-pop circuit of FIG. 1.

### DETAILED DESCRIPTION

The disclosure is illustrated by way of example and not by way of limitation in the figures of the accompanying drawings. It should be noted that references to “an” or “one” embodiment in this disclosure are not necessarily to the same embodiment, and such references mean at least one.

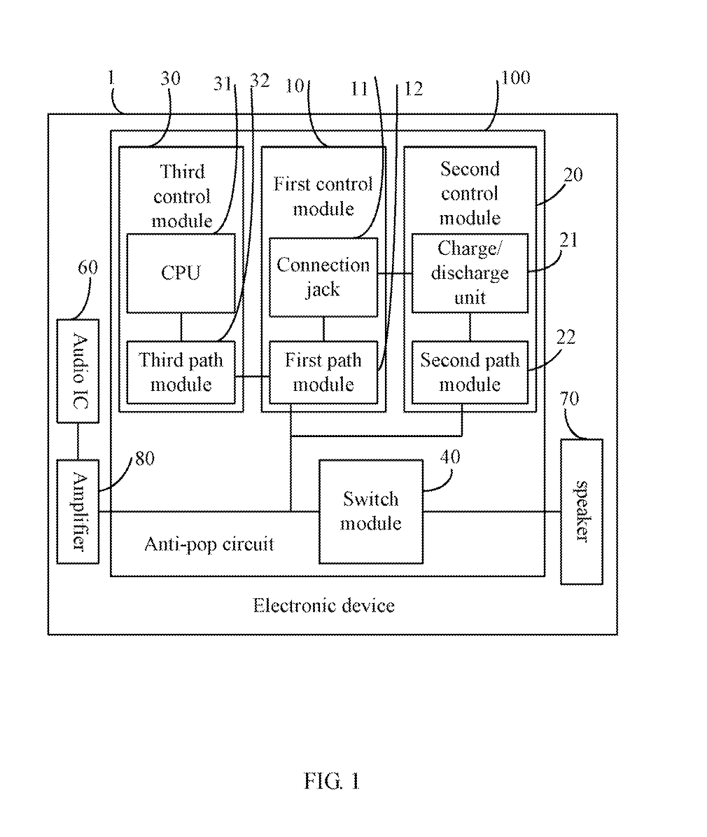

FIG. 1, is a block diagram of an anti-pop circuit 100. The anti-pop circuit 100 is used in an electronic device 1. The anti-pop circuit 100 includes a first control module 10, a second control module 20, a third control module 30, and a switch module 40. The first control module 10 includes a connection jack 11 and a first path module 12. The connection jack 11 is connected to a power supply 50 to receive power from the power supply 50. In the exemplary embodiment, the power supply 50 is a DC power supply.

The second control module 20 includes a charge/discharge unit 21 and a second path module 22. When the connection jack 11 is connected to the power supply 50, the power supply 50 charges the charge/discharge unit 21, and when the connection between the connection jack 11 and the power supply 50 is cut off, the charge/discharge unit 21 discharges.

The third control module 30 includes a CPU 31 and a third path module 32. When the electronic device 1 is being started or shut down, the power provided to the CPU 31 is cut off. When the electronic device 1 is started, the power supply 50 provides power to the CPU 31. When the electronic device 1 is muted, the CPU 31 outputs a high level signal to the third path module 32, and when the electronic device 1 is not muted, the CPU 31 outputs a low level signal to the third path module 32.

The switch module 40 is connected between an audio IC 60 and a speaker 70, and to control a connection between an audio IC 60 and a speaker 70. In the exemplary embodiment, the switch module 40 is connected between the audio IC 60 and the speaker 70 through an amplifier. When the connection between the audio IC 60 and the speaker 70 is disabled, the speaker 70 is muted, and when the connection between the audio IC 60 and the speaker 70 is enabled, the speaker 70 is amplified.

When the electronic device 1 is being started, namely, the connection jack 11 is connected to the power supply 50, the first path module 12 outputs a first response signal to the switch module 40. The switch module 40 cuts off the connection between the audio IC 60 and the speaker 70 in response to the first response signal. Simultaneously, when the connection jack 11 is connected to the power supply 50, the power supply 50 charges the charge/discharge unit 21.

When the electronic device 1 is being shut down, namely, the connection between the connection jack 11 and the power supply 50 is cut off, the charge/discharge unit 21 discharges to the second path module 22, the second path module 22 outputs a second response signal to the switch module 40, and the switch module 40 cuts off the connection between the audio IC 60 and the speaker 70 in response to the second response signal.

When the electronic device 1 is started and is muted, the CPU 31 outputs a high level signal to the third path module 32. The third path module 32 outputs a third response signal to the first path module 12. The first path module 12 outputs the first response signal to the switch module 40, the switch module 40 cuts off the connection between the audio IC 60 and the speaker 70 in response to the first response signal. When electronic device 1 is shut down and is not muted, the CPU 31 outputs a low level signal to the third path module 32. The third path module 32 outputs a fourth response signal to the first path module 12, the first path module 12 outputs a fifth response signal to the switch module 40 in response to the output fourth response signal. The switch module 40 establishes a connection between the audio IC 60 and the speaker 70 in response to the fifth response signal.

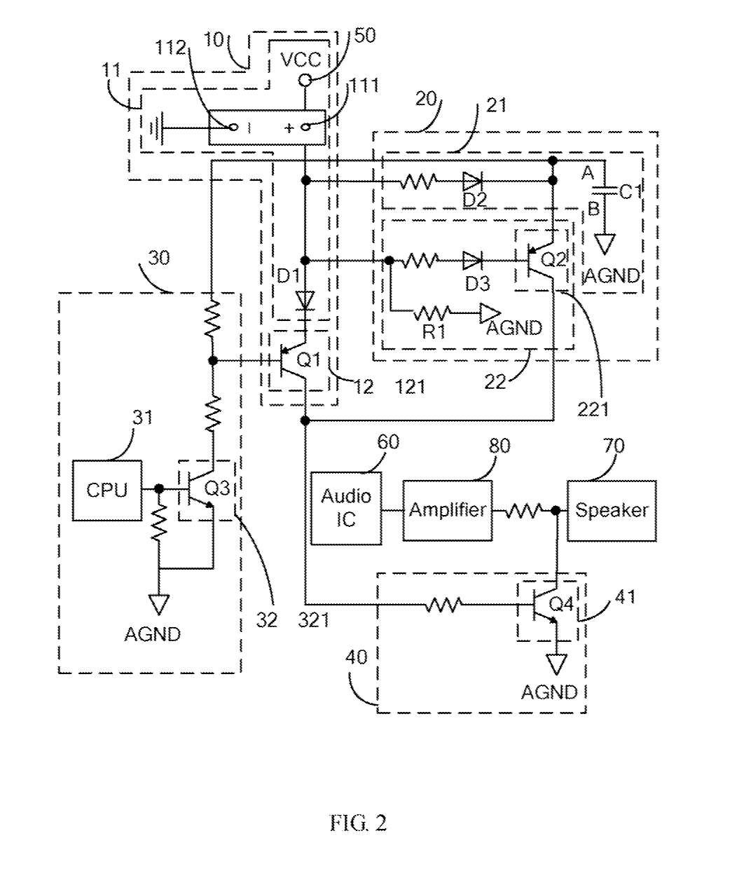

FIG. 2 shows a circuit diagram of the anti-pop circuit 100 in accordance with an exemplary embodiment.

The connection jack 11 includes an anode input port 111, a cathode input port 112, and a diode D1. The anode input port 111 and the cathode input port 112 are respectively connected to an anode and a cathode of the power supply 50. An anode of the diode D1 is connected to the charge/discharge unit 21, a second path module 22, and the anode of the power supply 50. A cathode of the diode D1 is connected to the first path module 12. In the exemplary embodiment, the power supply 50 is represented by VCC.

The first path module 12 is a low voltage activated switch 121. In the exemplary embodiment, the low voltage activated switch 121 is a p-n-p bipolar junction transistor (BJT) Q1. An emitter of the p-n-p BJT Q1 is connected to the anode of the diode D1. A base of the p-n-p BJT Q1 is connected to the third control module 30. A collector of the p-n-p BJT Q1 is connected to the switch module 40 and the second path module 22.

The charge/discharge unit 21 includes a capacitor C1 and a diode D2. The capacitor C1 includes a first terminal A and a second terminal B. The first terminal A of the capacitor C1 is connected to a cathode of the diode D2, the second path module 22, and the third control module 30, and the second terminal B of the capacitor C1 is grounded. An anode of the diode D2 is connected to the anode of the power, the anode of the diode D1, and the second path module 22.

The second path module 22 includes a low voltage activated switch 221, a diode D3, and a resistor R1. In the exemplary embodiment, the low voltage activated switch 221 is a p-n-p BJT Q2. The diode D2 and the diode D3 are connected in series between an emitter of the p-n-p BJT Q2 and a base of the p-n-p BJT Q2, a collector of the p-n-p BJT Q2 is connected to the collector of the p-n-p BJT Q1 and the switch module 40. An anode of the diode D3 is connected to the base of the p-n-p BJT Q2, a cathode of the diode D3 is grounded through the resistor R1, and is connected to the diode D1 and the anode of the power supply 50.

The third path module 32 is a high voltage activated switch 321. In the exemplary embodiment, the high voltage activated switch 321 is an n-p-n BJT Q3. An emitter of the n-p-n BJT Q3 is grounded, a base of the n-p-n BJT Q3 is connected to the CPU 31, and a collector of the n-p-n BJT Q3 is connected to the base of the p-n-p BJT Q1, the first terminal A of the capacitor, the anode of the diode D2, and the emitter of the p-n-p BJT Q2.

The switch module 40 is a high voltage activated switch 41. In the exemplary embodiment, the high voltage activated switch 41 is an n-p-n BJT Q4. An emitter of the n-p-n BJT Q4 is grounded, a base of the n-p-n BJT Q4 is connected to the collector of the p-n-p BJT Q1 and the collector of the p-n-p BJT Q2, and a collector of the p-n-p BJT Q4 is connected to the audio IC 60 and the speaker 70.

When the electronic device 1 is being started, namely, the anode input port 111 is connected to the anode of the power supply 50 and the power of the CPU 31 is cut off, the power supply 50 charges the capacitor C1 through the diode D2, the first terminal voltage of the capacitor C1 increases from 0 voltage, the base of the p-n-p BJT Q1 is equal to the first terminal voltage of the capacitor C1, thus the base of the p-n-p BJT Q1 is at low level. The power supply 50 provides a high level signal to the emitter of the p-n-p BJT Q1 through the diode D1, the emitter voltage of the p-n-p BJT Q1 is greater than the base voltage of the p-n-p BJT Q1, thus the p-n-p BJT Q1 is turned on. The power supply 50 provides a high level signal to the collector of the n-p-n BJT Q4 through the turned-on p-n-p BJT Q1, namely, the first path module 12 outputs a high level signal to the switch module 40. The base voltage of the n-p-n BJT Q4 is greater than the emitter voltage of the n-p-n BJT Q4, causing the n-p-n BJT Q4 to be turned on. The n-p-n BJT Q4 cuts off the connection between the audio IC 60 and the speaker 70, thus avoiding the “pop” sound when the electronic device 1 is being started.

When the electronic device 1 is started, the CPU 31 works normally, the capacitor C1 is charged completely. The CPU 31 outputs a high level signal to the base of the n-p-n BJT Q3 when the electronic device 1 is muted, the base voltage of the n-p-n BJT Q3 is greater than the emitter voltage of the n-p-n BJT Q3, thus the n-p-n BJT Q3 is turned on. The base of the p-n-p BJT Q1 is grounded through the turned-on n-p-n BJT Q3, namely, the third path module 32 outputs a low level signal to the base of the p-n-p BJT Q1. The power supply 50 provides a high level signal to the emitter of the p-n-p BJT Q1 through the diode D1, thus the emitter voltage of the p-n-p BJT Q1 is greater than the base voltage of the p-n-p BJT Q1, causing the p-n-p BJT Q1 to be turned on. The power supply 50 outputs a high level signal to the base of the n-p-n BJT Q4 through the turned-on p-n-p BJT Q1, namely, the first path module 12 outputs a high level signal to the switch module 40, thus the base voltage of the n-p-n BJT Q4 is greater than the emitter voltage of the n-p-n BJT Q4, causing the n-p-n BJT Q4 to be turned on, the n-p-n BJT Q4 cuts off the connection between the audio IC 60 and the speaker 70, thus the speaker 70 is muted.

The CPU 31 outputs a low level signal to the base of the n-p-n BJT Q3 when the electronic device 1 is not muted. The base voltage of the n-p-n BJT Q3 is equal to or less than the emitter voltage of the n-p-n BJT Q3, thus the n-p-n BJT Q3 is turned off. The base of the p-n-p BJT Q1 is connected to the first terminal A of the capacitor C1, causing the base voltage of the p-n-p BJT Q1 to be equal to the first terminal voltage of the capacitor C1, thus the base voltage of the p-n-p BJT Q1 is at high level, namely, the third path module 32 outputs a high level signal to the first path module 12. The power supply 50 provides a high level signal to the emitter of p-n-p BJT Q1 through the diode D1, the emitter voltage of the p-n-p BJT Q1 is equal to or less than the base voltage of the p-n-p BJT Q1, causing the p-n-p BJT to be turned off, the first path module 12 outputs a low level to the switch module 40. Thus the base voltage of the n-p-n BJT Q4 is equal to or less than the emitter voltage of the n-p-n BJT Q4, causing the n-p-n BJT Q4 to be turned off, the n-p-n BJT establishes the connection between the audio IC 60 and the speaker 70, thus the speaker 70 can output sounds corresponding to the signals output by the audio IC 60.

When the electronic device 1 is being shut down, namely, the connection between the anode input port 111 and the anode of the power supply 50 is cut off and the power of the CPU 31 is cut off, the capacitor C1 provides a high level signal to the emitter of the p-n-p BJT Q2. The base of the p-n-p BJT Q2 is grounded through the resistor R1, the base of the p-n-p BJT Q2 is at low level, thus the emitter voltage of the p-n-p BJT Q2 is greater than the base of the p-n-p BJT Q2, causing the p-n-p BJT Q2 to be turned on. The capacitor C1 provides a high level to the base of the n-p-n BJT Q4 through the turned-on p-n-p BJT Q2, namely, the second path module 22 outputs a high level signal to the switch module 40, thus the base voltage of the n-p-n BJT Q4 is greater than the emitter voltage of the n-p-n BJT Q4, causing the n-p-n BJT Q4 to be turned on, the n-p-n BJT Q4 cuts off the connection between the audio IC 60 and the speaker 70, thus avoiding the “pop” sound when the electronic device 1 is being shut down.

In this configuration, when the electronic device 1 is being started, the first control module 10 outputs a high level signal to the switch module 40, the switch module 40 cuts off the connection between the audio IC 60 and the speaker 70 in response to the high level signal, and when the electronic device 1 is being shut down, the second control module 20 outputs a high level signal to the switch module 40, the switch module 40 cuts off the connection between the audio IC 60 and the speaker 70 in response to the high level output by the second control module 20, thus avoiding the “pop” sound when the electronic device 1 is being started or shut down.

Although the current disclosure has been specifically described on the basis of the exemplary embodiment thereof, the disclosure is not to be construed as being limited thereto. Various changes or modifications may be made to the exemplary embodiment without departing from the scope and spirit of the disclosure.

What is claimed is:

1. An anti-pop circuit for use in an electronic device, the anti-pop circuit comprising:
a switch module connected between an audio IC and a speaker, and to control a connection between the audio IC and the speaker;
a first control module comprising:
a connection jack connected to a DC power supply when the electronic device is being started, and disconnected from the DC power supply when the electronic device is being shut down; and
a first path module outputting a first response signal to the switch module when the electronic device is being started, the switch module cutting off the connection between the audio IC and the speaker in response to the first response signal output by the first path module; and
a second control module comprising:
a charge/discharge unit charged by the DC power supply when the electronic device is being started, and discharging to the second path module when the electronic device is being shut down; and
a second path module outputting a second response signal to the switch module when the electronic device is being shut down, the switch module cutting off a connection between the audio IC and the speaker in response to the second response signal output by the second path module.

2. The anti-pop circuit as described in claim 1, further comprising a third control module, wherein the third control module comprises a central processing unit (CPU) and a third path module, when the electronic device is started and is muted, the CPU outputs a high level signal to the third path module, the third path module outputs a third response signal to the first path module in response to the high level signal output by the CPU, the first path module outputs the first response signal to the switch module in response to the third response signal output by the third path module; when the electronic device is started and is not muted, the CPU outputs a low level signal to the third path module, the third path module outputs a fourth response signal to the first path module in response to the low level output by the CPU, the first path module outputs a fifth response signal to the switch module in response to the fourth response signal output by the third path module.

3. The anti-pop circuit as described in claim 2, wherein the connection jack comprises an anode input port, a cathode input port, and a diode, the anode input port and the cathode input port are respectively connected to the anode and the cathode of the power supply, an anode of the diode is connected to the charge/discharge unit, the second path module, and the anode of the power supply, a cathode of the diode is connected to the first path module.

4. The anti-pop circuit as described in claim 3, wherein the first path module comprises a low voltage activated switch, a first terminal of the low voltage activated switch is connected to the cathode of the diode, a second terminal of the low voltage activated switch is connected to the third control module and the second path module, and a third terminal of the low voltage activated switch is connected to the switch module and the second path module.

5. The anti-pop circuit as described in claim 4, wherein the low voltage activated switch is a p-n-p bipolar junction transistor (BJT).

6. The anti-pop circuit as described in claim 5, wherein an emitter of the p-n-p BJT is connected to the cathode of the diode, a base of the p-n-p BJT is connected to the third control module and the second path module, and a collector of the p-n-p BJT is connected to the switch module and the second path module.

7. The anti-pop circuit as described in claim 2, wherein the charge/discharge unit comprises a capacitor and a diode, the capacitor comprises a first terminal and a second terminal, the first terminal of the capacitor is connected to an anode of the diode, the second path module, and the third control module, and the second terminal of the capacitor is grounded, a cathode of the diode is connected to the anode of the power, the connection jack, and the second path module.

8. The anti-pop circuit as described in claim 7, wherein the second path module comprises a low voltage activated switch, a diode, and a resistor, a first terminal of the low voltage activated switch is connected to the cathode of the charge/discharge unit and the capacitor, a second terminal of the low voltage activated switch is connected to the connection jack through the diode of the second path module, and is grounded through the diode of the second path module and the resistor, a third terminal of the low voltage activated switch is connected to the first path module and the switch module.

9. The anti-pop circuit as described in claim 8, wherein the low voltage activated switch is a p-n-p bipolar junction transistor (BJT).

10. The anti-pop circuit as described in claim 9, wherein the diode of the charge/discharge unit and the diode of the second path module are connected in series between an emitter of the p-n-p BJT and a base of the p-n-p BJT, and are connected to the connection jack, a collector of the p-n-p BJT is connected to the first path module and the switch module.

11. The anti-pop circuit as described in claim 2, wherein the third path module comprises a high voltage activated switch, a first terminal of the high voltage activated switch is connected to the CPU, a second terminal of the high voltage activated switch is grounded, and a third terminal of the high voltage activated switch is connected to the first path module, the charge/discharge unit, and the second path module.

12. The anti-pop circuit as described in claim 11, wherein the high voltage activated switch is an n-p-n bipolar junction transistor (BJT).

13. The anti-pop circuit as described in claim 12, wherein an emitter of the n-p-n BJT is grounded, a base of the n-p-n BJT is connected to the CPU, and a collector of the n-p-n BJT is connected to the first path module, the charge/discharge unit, and the second path module.

14. The anti-pop circuit as described in claim 2, wherein the switch module is a high voltage activated switch, a first terminal of the high voltage activated switch is connected to the first path module and the second path module, a second terminal of the high activated switch is grounded, and a third terminal of the high activated switch is connected to the audio IC and the speaker.

15. The anti-pop circuit as described in claim 14, wherein the high voltage activated switch is an n-p-n bipolar junction transistor (BJT).

16. The anti-pop circuit as described in claim 15, wherein an emitter of the n-p-n BJT is grounded, a base of the n-p-n BJT is connected to the first path module and the second path module, and a collector of the n-p-n BJT is connected to the audio IC and the speaker.
